(19) United States
(12) Patent Application Publication
(10) Pub. No.: US 2024/0017803 A1
(43) Pub. Date: Jan. 18, 2024

(54) WATER ACTIVATED EMERGENCY FLOTATION DEVICE

(71) Applicant: Christopher M Sobjak, Hanover, PA (US)

(72) Inventor: Christopher M Sobjak, Hanover, PA (US)

(21) Appl. No.: 17/864,401

(22) Filed: Jul. 14, 2022

(51) Int. Cl. B63C 9/125; A01K 27/00

(52) U.S. Cl. CPC B63C 9/1255; A01K 27/002; B63C 2009/0041

(57) ABSTRACT

An emergency flotation harness that provides for a water-activated flotation vest for a pet such as a dog, that automatically self-inflates when exposed to water such as a pool, lake, pond, river to protect the pet from drowning. The harness would be worn by a pet and made available in multiple sizes such as small, medium, large, and extra-large to fit a wide variety of pets of different ages and sizes. The harness would be made of multiple sections of straps, such as waterproof nylon. To further allow for exact sizing, the harness would consist of multiple adjustment clips, to allow for adjustment of the straps to exactly fit the pet or as it grows.

### FIELD OF THE INVENTION

This invention relates to personal flotation devices. More particularly, it relates to personal flotation device for a pet activated when coming in contact with water.

### BACKGROUND

A personal flotation device (PFD; also referred to as a life jacket, life preserver, life belt, Mae West, life vest, life saver, cork jacket, buoyancy aid or flotation suit) is a flotation device in the form of a vest or suite that is worn by a user to prevent the wearer from drowning in a body of water. The device will keep the wearer afloat with their head and mouth above the surface—they do not have to swim or tread water in order to stay afloat and can even be unconscious.

Personal flotation devices have been developed for dogs and other pets, While the United States Coast Guard does not certify personal flotation devices for animals, many manufacturers produce lifejackets for dogs and cats. Dogs and cats have been known to die from drowning, either because they do not know how to swim, or because they tire out from overexposure or old age, or have a medical complication such as a seizure, or become unconscious.

Most lifejackets on the market are designed with foam that wraps around the animal's torso and neck. They provide a basic amount of buoyancy for a dog but may not provide enough support for the head. They are not ideal for use with heavy dogs. However, they often incorporate a grab handle, which may help to hoist the dog back into the boat.

With the personal floatation devices that exist today for animals there are none available that inflate on their own when touched by a body of water in an emergency situation to keep an animal safe from drowning.

Accordingly, and in light of the foregoing, it would be desirable to have an emergency flotation harness that provides for a water-activated flotation vest for a pet such as a dog, that automatically self-inflates when exposed to water such as a pool, lake, pond, river to protect the pet from drowning. The harness would be worn by a pet and made available in multiple sizes such as small, medium, large, and extra-large to fit a wide variety of pets of different ages and sizes. The harness would be made of multiple sections of straps, such as waterproof nylon. To further allow for exact sizing, the harness would consist of multiple adjustment clips, to allow for adjustment of the straps to exactly fit the pet or as it grows.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a front view of the emergency flotation harness 10, according to the preferred embodiment of the present invention;

FIG. 2 is a top view of the emergency flotation harness 10, according to the preferred embodiment of the present invention;

FIG. 3 is a pictorial view of a pet 15, wearing the emergency flotation harness 10 in a non-activated state, according to the preferred embodiment of the present invention;

FIG. 4 is a pictorial view of a pet 15, wearing the emergency flotation harness 10 in a non-activated state, according to the preferred embodiment of the present invention;

FIG. 5 is a sectional view of the emergency flotation harness 10, as seen along a line I-I, as shown in FIG. 3, according to the preferred embodiment of the present invention; and,

FIG. 6 is a sectional view of the emergency flotation harness for pets 10, as seen along a line II-II, as shown in FIG. 4, according to the preferred embodiment of the present invention.

### DESCRIPTIVE KEY

10 emergency flotation harness
15 pet
20 strap
25 adjustment clip
30 buckle
35 front flotation compartment
40 front inflation bladder (deflated)
45 front sensor
50 top flotation compartment
55 top inflation bladder (deflated)
60 top sensor
65 attachment loop
70 carrying handle
75 body of water
80 front inflation bladder (inflated)
85 top inflation bladder (inflated)
90 head DESCRIPTION OF THE PREFERRED EMBODIMENTS

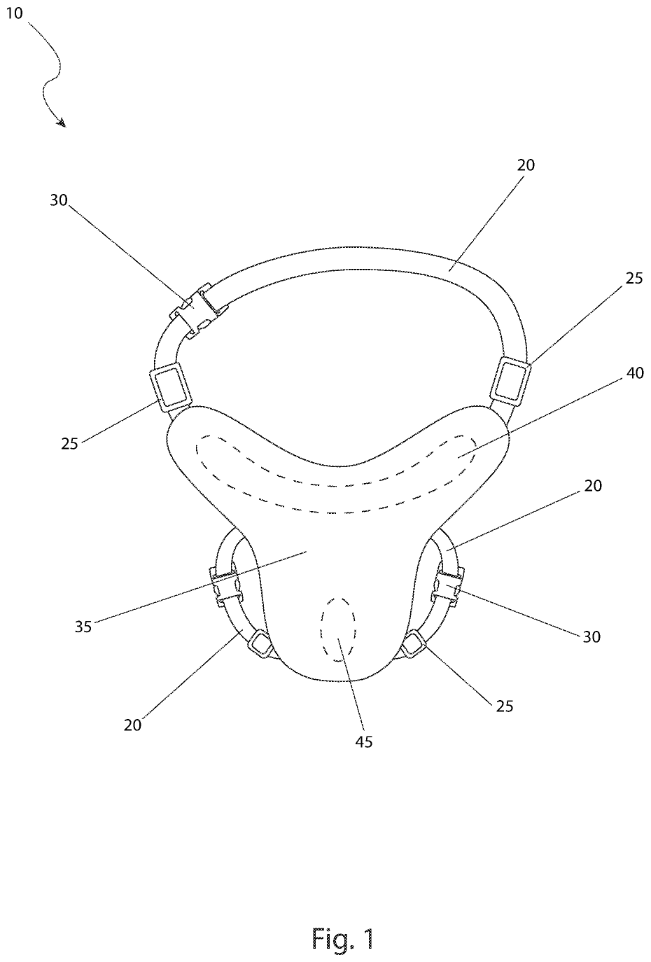

The best mode for carrying out the invention is presented in terms of its preferred embodiment, herein depicted within FIGS. 1 through 6. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one (1) particular configuration shall be shown and described for purposes of clarity and disclosure and not by way of limitation of scope. All of the implementations described below are exemplary implementations provided to enable persons skilled in the art to make or use the embodiments of the disclosure and are not intended to limit the scope of the disclosure, which is defined by the claims.

The terms “a” and “an” herein do not denote a limitation of quantity, but rather denote the presence of at least one (1) of the referenced items.

### 1. Detailed Description of the Figures

Referring now to FIG. 1, a front view of the emergency flotation harness 10, according to the preferred embodiment of the present invention is disclosed. The emergency flotation harness (herein also described as the “harness”) 10, provides for a water-activated flotation vest for a pet 15, such as a dog, that automatically self-inflates when exposed to water 75 to protect the pet 15 from drowning. The harness 10 would be worn by a pet 15 (not shown in this figure) and made available in multiple sizes such as small, medium, large, and extra-large to fit a wide variety of pets 15 of different ages and sizes. The harness 10 would be made of multiple sections of straps 20, such as waterproof nylon. To further allow for exact sizing, the harness 10 consists of multiple adjustment clips 25, to allow for adjustment of the straps 20 to exactly fit the pet 15 or as it grows.

To allow for easy application and removal of the harness 10, it is provided with a plurality of buckles 30 that open and close in a quick but secure manner. A front flotation compartment 35 is visible in mechanical communication with multiple straps 20. The front flotation compartment 35 is provided with a front inflation bladder (deflated) 40 (enclosed within and thus shown by dashed lines) in a non-activated state. The front flotation compartment 35 is also provided with a front sensor 45 (enclosed within and thus shown by dashed lines). Further description on the configuration and operation of the front inflation bladder (deflated) 40 and the front sensor 45 will be provided herein below.

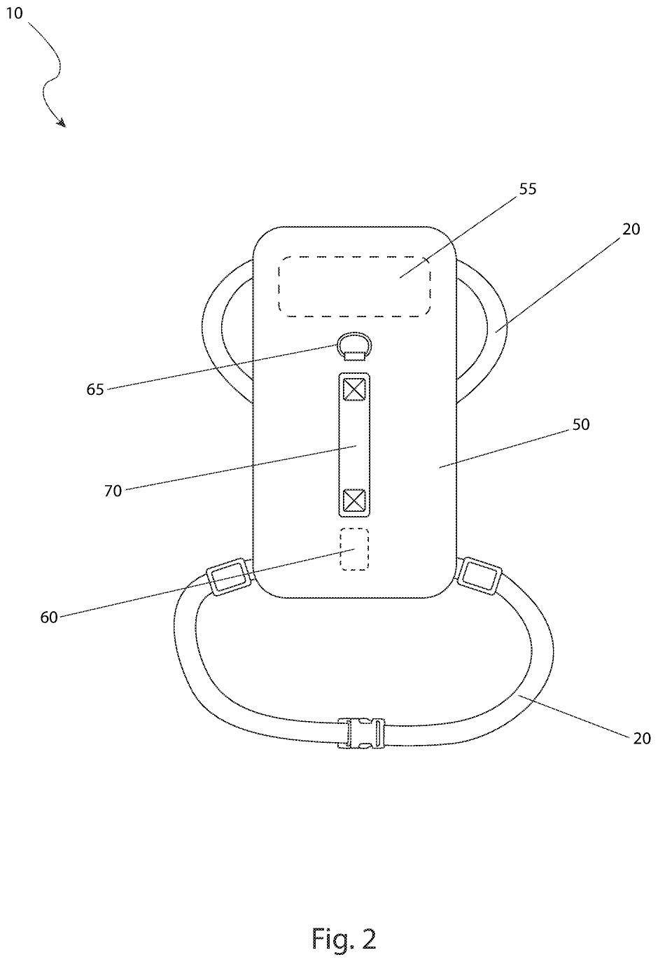

Referring next to FIG. 2, a top view of the harness 10, according to the preferred embodiment of the present invention is depicted. The harness 10 also provides for a top flotation compartment 50, held in place by multiple connections with the straps 20. The top flotation compartment 50 is provided with a top inflation bladder (deflated) 55 (enclosed within and thus shown by dashed lines) in a non-activated state. The top flotation compartment 50 is also provided with a top sensor 60 (enclosed within and thus shown by dashed lines). Further description on the configuration and operation of the front inflation bladder (deflated) 40 and the front sensor 45 will be provided herein below. An attachment loop 65 is located on the forward portion of the top flotation compartment 50 for the attachment of leashes, leads, restraints, runs and the like in much the same manner as a conventional harness. A center-mounted carrying handle 70 is located atop the top flotation compartment 50 and allows for safe lifting of the pet 15 (not shown in this FIGURE) in the event of an emergency, such as retrieval from a body of water.

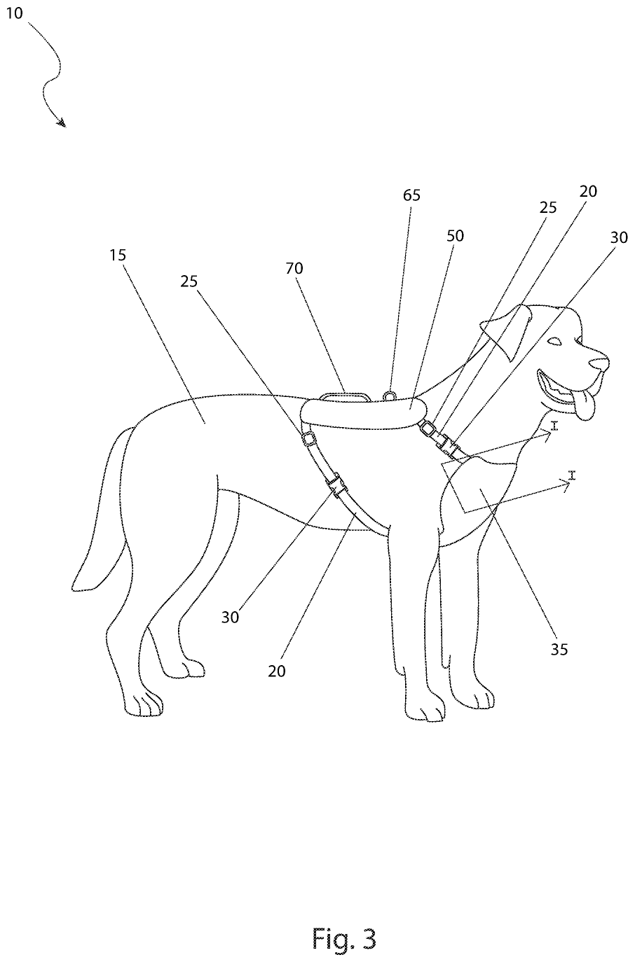

Referring now to FIG. 3, a pictorial view of a pet 15, wearing the harness 10 in a non-activated state, according to the preferred embodiment of the present invention is shown. Both the front flotation compartment 35 and the top flotation compartment 50 are secured to the pet 15 by use of the straps 20. During initial application of the harness 10, the adjustment clips 25 are positioned to accommodate the exact dimensions of the pet 15. Thereafter, the harness 10 is applied and removed from the pet 15 by use of the buckles 30. The attachment loop 65 on top of the top flotation compartment 50 allows for easy attachment of a leash, run, tether, or other means of securing the pet 15, and in fact, operates in a transparent manner to that of conventional harnesses. The carrying handle 70 may be used to secure or guide the pet 15 as needed, perhaps when a leash is not attached to the attachment loop 65.

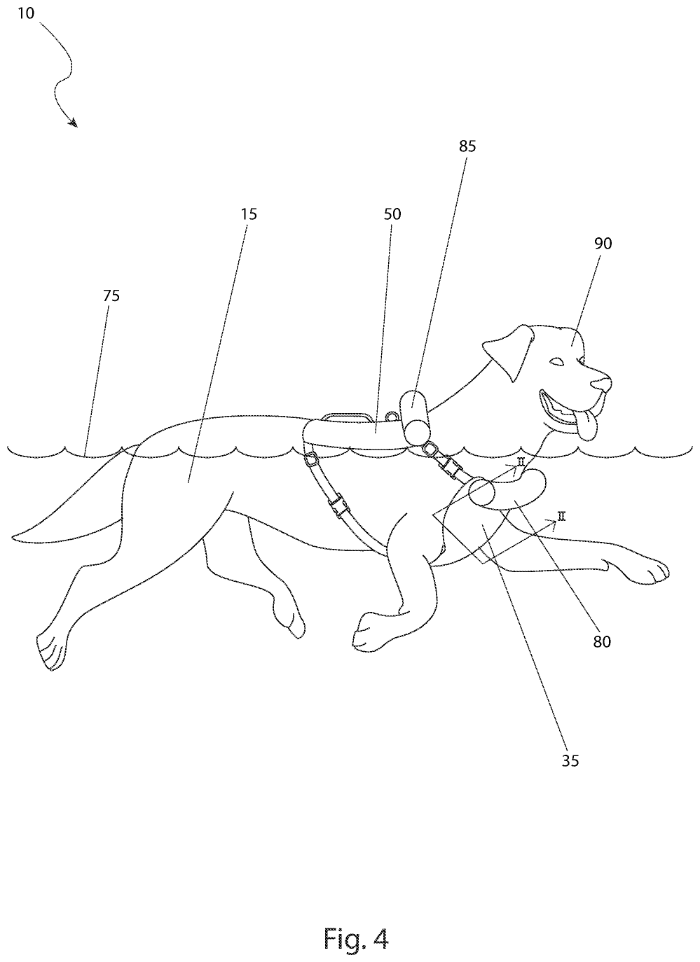

Referring next to FIG. 4, a pictorial view of a pet 15, wearing the harness 10 in a non-activated state, according to the preferred embodiment of the present invention is disclosed. In said view, the pet 15 is in a body of water 75, such as a pool, lake, pond, river, or the like, that occurred as a result of an emergency or accidental situation. It is noted that the harness 10 would not be used when it is intended that the pet 15 would enter a body of water 75. In such cases, the owner or caretaker of the pet 15 would remove the harness 10 and apply a conventional flotation harness. When the front sensor 45 (as shown in FIG. 1) and/or the top sensor 60 become exposed to the body of water 75, a resultant actuation would cause the front inflation bladder (deflated) 40 (as shown in FIG. 1) and the top inflation bladder (deflated) 55 (as shown in FIG. 2) to respectively inflate. The front inflation bladder (deflated) 40 would inflate into a front inflation bladder (inflated) 80, and the top inflation bladder (deflated)55 would inflate into a top inflation bladder (inflated)85. Inflation may occur by a number of methods such as electronic detection and a battery powered circuit, a pressurized gas canister, a mechanical sensing means, or the like. As various methods of automatic bladder inflation are well-known in the art, the exact method of inflation is not intended to be a limiting factor of the present invention. The floating nature of the front inflation bladder (inflated) 80 and the top inflation bladder (inflated) 85 are adequate to allow the head 90 of the pet 15 (including the nose and mouth) to safely remain out of the body of water 75 for an almost unlimited period of time until self-rescue by the pet 15, or rescue by others (owner, care provider, by-standers, and the like) can occur. It is envisioned that the inflating nature of the harness 10 would be one-time occurrence, thus requiring the harness 10 to be discarded and a new harness 10 needed to be procured.

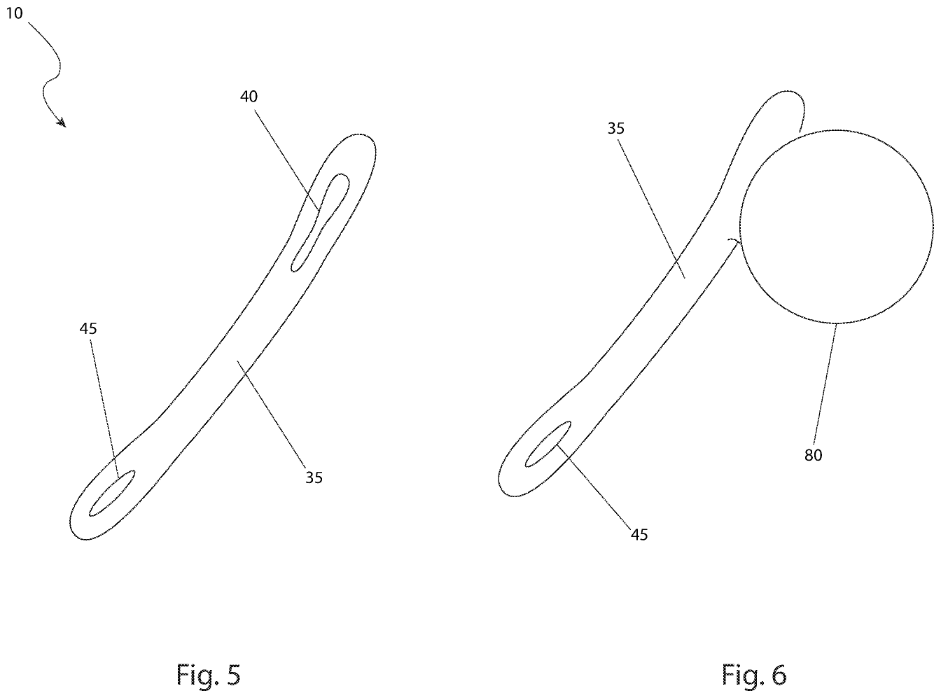

Referring now to FIG. 5, a sectional view of the harness 10, as seen along a line I-I, as shown in FIG. 3, according to the preferred embodiment of the present invention is depicted. The front inflation bladder (deflated) 40 and the front sensor 45 are encased within the front flotation compartment 35 as aforementioned described. This configuration presents a slim, non-bulky, low-profile design that allows the harness 10 to be worn at all times. It is noted, though not specifically illustrated, that the top flotation compartment 50, the top inflation bladder (deflated) 55 and the top sensor 60 (all of which are shown in FIG. 2) are configured and operate in an identical manner to that of the front flotation compartment 35, the front inflation bladder (deflated) 40 and the front sensor 45 as aforementioned described, albeit in an independent manner. The protective nature of the front flotation compartment 35 (and the top flotation compartment 50) shields the front sensor 45 (and the top sensor 60) against incidental contact with water such as may occur with rain, the pet 15 drinking from a water dish, splashing in a puddle, or the like, and will not result in actuation of inflation.

Referring to FIG. 6, a sectional view of the harness 10, as seen along a line II-II, as shown in FIG. 4, according to the preferred embodiment of the present invention is shown. The front sensor 45 remains encased within the front flotation compartment 35 as aforementioned described. The front inflation bladder (inflated)80 now protrudes through the surface of the front flotation compartment 35 due to its large size, and serves to aid in flotation of the pet 15 (as shown in FIG. 4). It is noted, though not specifically illustrated, that the top flotation compartment 50, the top inflation bladder (inflated) 85 and the top sensor 60 (all of which are shown in FIGS. 2 and 4) are configured and operate in an identical manner to that of the front flotation compartment 35, the front inflation bladder (inflated)80 and the front sensor 45 as aforementioned described, albeit in an independent manner.

### 2. Operation of the Preferred Embodiment

The preferred embodiment of the present invention can be utilized by the common user in a simple and effortless manner with little or no training. It is envisioned that the harness 10 would be constructed in general accordance with FIG. 1 through FIG. 6. The user would procure the harness 10 from conventional procurement channels such as pet supply stores, marine supply houses, discount stores, department stores, mail order and internet supply houses and the like. Special attention would be paid to the overall initial size of the harness 10 (small, medium, large, extra-large, and the like) for use on the intended pet 15.

After procurement and prior to utilization, the harness 10, initial sizing would be made by adjusting the adjustment clips 25 on the straps 20 such that the harness 10 comfortably, but securely fits the pet 15 and that the pet 15 cannot pull out of the harness 10. Removal and subsequent attachment of the harness 10 to the pet 15, may be made by use of the buckles 30 alone. It is intended that the pet 15 wears the harness 10 at all times, as it is never known when the pet 15 may be accidentally immersed in a body of water 75 that they cannot escape from.

During actuation of the harness 10, when the pet 15 is accidentally immersed in a body of water 75 (as shown in FIG. 4), the front sensor 45 and/or the top sensor 60, in contact with the body of water 75, will result in the transformation of the front inflation bladder (deflated) 40 into the front inflation bladder (inflated)80, and/or the transformation of the top inflation bladder (deflated) 55 into the top inflation bladder (inflated) 85. The inflated nature of the front inflation bladder (inflated) 80 and the top inflation bladder (inflated)85 results in buoyancy allowing the pet 15 to be self-rescued or rescued by others.

After activation and utilization of the harness 10, the harness 10 would be discarded and replaced.

The features of the harness 10 provide the following benefits: the harness 10 is lightweight, keeps valuable pets 15 afloat in a body of water 75 until rescue can occur, adjustable, made in a wide variety of sizes, ability to attach a leash or other restraint system, the carrying handle 70 allows for easy retrieval of the pet 15 from a body of water 75, perfect for use on pet 15 that cannot swim, pet 15 that may be elderly, disabled pets, or cannot swim for long periods of time; perfect for use on pet 15 that may be around body of water 75 such as pools, ponds, lakes, streams, or while on boats.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. An emergency flotation harness device for a pet, the emergency flotation harness device comprising:
a front flotation compartment;
a front inflation bladder, the front inflation bladder configured to be enclosed with the front flotation compartment;
a sensor, the sensor being coupled to the front flotation bladder, wherein the sensor configured to detect water; and
multiple straps, each of the multiple straps are configured to mechanically communicate with the front flotation compartment.

2. The emergency flotation harness device according to claim 1, wherein the emergency flotation harness further comprising:
a top front flotation compartment;
each of the straps coupled to the top front flotation compartment;
a top sensor, the top sensor being coupled to the top flotation compartment, the sensor being configured to detect water; and
a top inflation bladder, the top inflation bladder coupled to the front flotation compartment.

3. The emergency flotation harness device according to claim 2, wherein when the top sensor detects the presence of water, the top flotation bladder is actuated.

4. The emergency flotation harness device according to claim 3, wherein when the top flotation bladder inflates, the top flotation device inflates into the top flotation compartment.

5. The emergency flotation harness device according to claim 2, wherein the top flotation compartment is configured to shield the top sensor from incidental contact with water.

6. The emergency flotation harness device according to claim 5, wherein the water is from a water dish.

7. The emergency flotation harness device according to claim 1, wherein the emergency flotation harness device further comprising a plurality of buckles, wherein the buckles being coupled to the straps.

8. The emergency flotation harness device according to claim 1, wherein each of the buckles coupled to the straps allows for the adjustability of the straps.

9. The emergency flotation harness device according to claim 1, wherein each of the straps is adjustable in length.

10. The emergency flotation harness device according to claim 1, wherein when the front sensor detects the presence of water, the front flotation bladder is actuated.

11. The emergency flotation harness device according to claim 10, wherein when the front flotation bladder inflates, the front flotation device inflates into the front flotation compartment.

12. The emergency flotation harness device according to claim 10, wherein the water is from a pool.

13. The emergency flotation harness device according to claim 10, wherein the water is from a lake.

14. The emergency flotation harness device according to claim 10, wherein the water is from a pond.

15. The emergency flotation harness device according to claim 10, wherein the water is from a river.

16. The emergency flotation harness device according to claim 1, wherein the front flotation compartment is configured to receive an attachment.

17. The emergency flotation harness device according to claim 16, wherein the attachment is a leash.

18. The emergency flotation harness device according to claim 16, wherein the attachment is a run.

19. The emergency flotation harness device according to claim 1, wherein the front flotation compartment is configured to shield the front sensor from incidental contact with water.

20. The emergency flotation harness device according to claim 19, wherein the water is from a water dish.
